(19) United States
(12) Patent Application Publication
(10) Pub. No.: US 2024/0001673 A1
(43) Pub. Date: Jan. 4, 2024

(54) DISCHARGE HEAD, HEAD MODULE, AND DISCHARGE APPARATUS

(71) Applicant: Takeshi MIYAZAKI, Kanagawa (JP)

(72) Inventor: Takeshi MIYAZAKI, Kanagawa (JP)

(21) Appl. No.: 18/212,722

(22) Filed: Jun. 22, 2023

(30) Foreign Application Priority Data
Jun. 30, 2022 (JP) 2022-105237

(51) Int. Cl. B41J 2/14

(52) U.S. Cl. CPC B41J 2/1433

(57) ABSTRACT

A discharge head includes a nozzle plate, a channel substrate, and a protector. The nozzle plate has a discharge face having nozzles from which a material is discharged in a discharge direction. The channel substrate is disposed on the nozzle plate. The channel substrate has a channel communicating with the nozzles. The protector is bonded to both sides of the nozzle plate in a first direction orthogonal to the discharge direction with a resin. The resin covers an outer edge portion of the discharge face in the first direction. The resin extends in a second direction intersecting the first direction.

### CROSS-REFERENCE TO RELATED APPLICATION

This patent application is based on and claims priority pursuant to 35 U.S.C. § 119(a) to Japanese Patent Application No. 2022-105237, filed on Jun. 30, 2022, in the Japan Patent Office, the entire disclosure of which is hereby incorporated by reference herein.

### BACKGROUND

### Technical Field

Embodiments of the present disclosure relate to a discharge head, a head module, and a discharge apparatus.

### Related Art

A discharge head discharges a liquid from a nozzle. A head module includes a plurality of discharge heads. The nozzle is disposed in a nozzle face of the discharge head.

An outer edge portion of the nozzle face may be covered by a cover.

### SUMMARY

Embodiments of the present disclosure describe an improved discharge head that includes a nozzle plate, a channel substrate, and a protector. The nozzle plate has a discharge face having nozzles from which a material is discharged in a discharge direction. The channel substrate is disposed on the nozzle plate. The channel substrate has a channel communicating with the nozzles. The protector is bonded to both sides of the nozzle plate in a first direction orthogonal to the discharge direction with a resin. The resin covers an outer edge portion of the discharge face in the first direction. The resin extends in a second direction intersecting the first direction.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a cross-sectional view of a discharge head according to a first embodiment of the present disclosure, taken along line A-A in FIG. 2;

FIG. 2 is a schematic plan view of the discharge head as viewed from a nozzle face side thereof:

FIG. 3 is a schematic perspective view of the discharge head as viewed from a port side thereof:

FIG. 4 is a cross-sectional view, which is similar to FIG. 1, of the discharge head according to a second embodiment of the present disclosure;

FIG. 5 is a schematic plan view of a head module according to a third embodiment of the present disclosure as viewed from the nozzle face side thereof;

FIG. 6 is a schematic plan view of the head module as viewed from the port side thereof; and

FIG. 7 is a schematic view of a discharge apparatus according to embodiments of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a.” “an,” and “the” are intended to include the plural forms as well, unless the context clearly indicates otherwise.

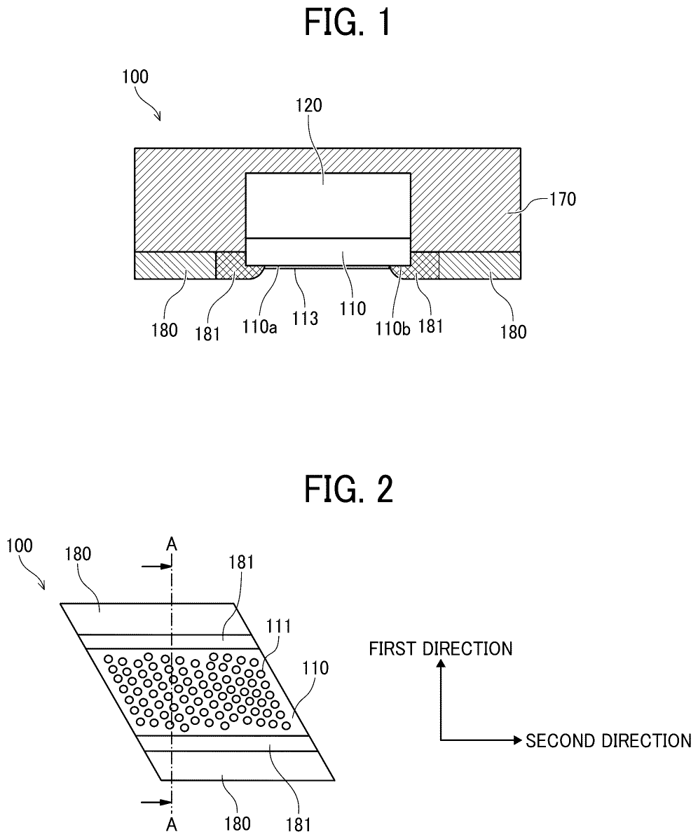

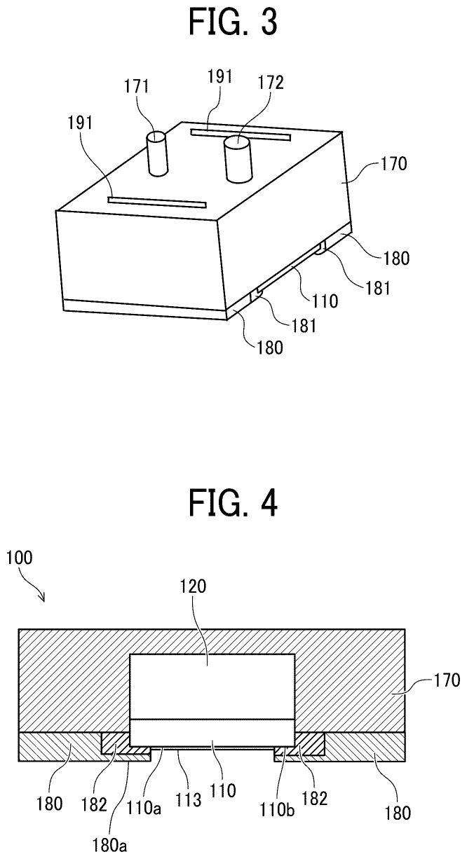

Embodiments of the present disclosure are described below with reference to the accompanying drawings. A first embodiment of the present disclosure is described below with reference to FIGS. 1 to 3. FIG. 1 is a cross-sectional view of a discharge head 100 according to the present embodiment, taken along line A-A in FIG. 2. FIG. 2 is a schematic plan view of the discharge head 100 as viewed from a nozzle face side (a surface of a nozzle plate 110 on which multiple nozzles 111 are arrayed). FIG. 3 is a schematic perspective view of the discharge head 100 as viewed from ink ports 171 and 172 side.

The discharge head 100 includes the nozzle plate 110, a channel substrate 120, and a housing (frame) 170. The multiple nozzles 111 are arrayed in a two dimensional matrix in the nozzle plate 110. A liquid as a material to be discharged, such as ink, is discharged from the nozzles 111. The channel substrate 120 has an internal channel communicating with the nozzles 111. The housing 170 holds the nozzle plate 110 and the channel substrate 120. The housing 170 is provided with the ink ports 171 and 172 and an electrical connector 191.

Protectors 180 are disposed on both sides of the nozzle plate 110 in a transverse direction of the nozzle plate 110, which is a first direction orthogonal to a discharge direction. The protector 180 is bonded to both sides of the housing 170 in the first direction. A nozzle face 110a is recessed from a surface of the protector 180 in the discharge direction. The nozzle face 110a is a discharge face of the nozzle plate 110, and the material is discharged from the nozzles 111 on the discharge face in the discharge direction.

A seal 181 made of resin fills a space between an outer side face of the nozzle plate 110 extending in a longitudinal direction of the nozzle plate 110, a surface of the housing 170 to which the protector 180 is bonded, and the protector 180. The longitudinal direction is a second direction intersecting the first direction. As a result, the protector 180 is bonded to the nozzle plate 110 with the seal 181 made of resin.

The seal 181 made of resin covers an outer edge portion 110b of the nozzle face 110a. The seal 181 also covers a surface of the housing 170 between the outer edge portion 110b of the nozzle face 110a and an inner edge of the protector 180 adjacent to the outer edge portion 110b in the first direction. The seal 181 extends in the second direction on the nozzle face 110a which is the discharge surface of the nozzle plate 110 along the outer edge portion 110b. In other words, an end of the seal 181 made of resin adjacent to the nozzle plate 110 is located between an outer edge of the nozzle plate 110 and a nozzle region where the nozzles 111 are arrayed in plan view. That is, the seal 181 covers an end region between the outer edge portion 110b of the nozzle face 110a and an outer end of the nozzle region in the first direction.

A liquid repellent film 113 is disposed on the nozzle face 110a, which is the discharge surface of the nozzle plate 110, except for the end region covered with the seal 181. That is, a liquid-repellent treatment is not applied to the outer edge portion 110b covered with the seal 181. Accordingly, the adhesiveness between the seal 181 and the nozzle face 110a of the nozzle plate 110 can be enhanced.

As described above, the protector is bonded to the nozzle plate with resin (i.e., the seal), and the resin covers the outer edge portion of the nozzle plate extending in the second direction intersecting the first direction. As a result, the edge of the nozzle plate is protected to withstand an external force.

An example of a manufacturing process of the discharge head 100 is described below. Although metal such as stainless steel or nickel or resin such as polyimide can be used for the nozzle plate 110, silicon is used in the present embodiment to form holes (nozzle holes) serving as the nozzles 111 with high accuracy. Nozzle holes from which ink is discharged are formed in a silicon wafer having a thickness of 600 μm by photolithography and dry etching. The nozzle hole has a diameter of 0.02 mm. Thereafter, the wafer is polished to a thickness of 100 μm and cut into the nozzle plates 110 by dicing.

After the above processes, a water repellent film as the liquid repellent film 113 is formed only on the nozzle face 110a of the nozzle plate 110. Then, the water repellent film is removed from a range between the nozzle region where the nozzles 111 are arrayed and the outer edge of the nozzle plate 110 in the transverse direction, that is, the outer edge portion 110b extending in the second direction (longitudinal direction). An area of the nozzle face 110a from which the water repellent film is not removed is protected with a tape, and the nozzle face 110a is processed by a plasma treatment to remove the water repellent film.

The channel substrate 120 has a channel for supplying ink to the nozzles 111 of the nozzle plate 110. A SiO₂ film with a thickness of 0.6 μm, a Si film with a thickness of 1.5 μm, and a SiO₂ film with a thickness of 0.4 μm are laminated over the silicon wafer having the thickness of 600 μm to form a three layer diaphragm. A Ti film with a thickness of 20 nm and a Pt film with a thickness of 200 nm are formed as a lower electrode over the diaphragm by sputtering.

Then, a film with a thickness of 2 μm is formed over the lower electrode by sol-gel method using an organic metal solution containing lead zirconate titanate (PZT), and the film is sintered at 700° C. to form a piezoelectric film of PZT. Thereafter, a Pt film with a thickness of 200 nm is formed as an upper electrode over the piezoelectric film by sputtering.

After the upper electrode is formed, the upper electrode, the piezoelectric film, and the lower electrode are patterned by dry etching to form piezoelectric elements corresponding to pressure chambers. A movable portion of the diaphragm does not overlap a portion above a partition wall between the pressure chambers. This configuration does not hinder the diaphragm corresponding to the pressure chamber from deforming.

Next, an interlayer insulating film is formed over the upper and lower electrodes by plasma chemical vapor deposition (CVD), and contact holes are formed in the interlayer insulating film. Then, a Ti film with a thickness of 50 nm and an Al film with a thickness of 2 μm are sequentially laminated, and a wiring layer is formed by dry etching. A portion of the diaphragm corresponding to an ink supply port is dry-etched to complete a wafer which is a base of a liquid chamber substrate.

Next, a holding substrate is formed using a silicon wafer. The holding substrate has a holding substrate recess and a holding substrate opening to be a supply port. The wafer is polished to a thickness of 400 μm, and an oxide film or the like is formed over the liquid chamber substrate side of the wafer. The oxide film is patterned by photolithography so as to open the holding substrate recess and the supply port.

A resist is further formed over the oxide film, and the resist is patterned by photolithography so as to open only the holding substrate opening. Then, a through opening is formed from the liquid chamber substrate side by inductively coupled plasma (ICP) etching. Only the resist on the liquid chamber substrate side is removed, and the liquid chamber substrate side of the wafer is half-etched by ICP etching using the oxide film pattern, which has been patterned first, as a mask. Finally, the oxide film is removed, thereby forming the recess on the liquid chamber substrate side and the through opening.

An epoxy-based adhesive is applied to a surface to be bonded of the prepared holding substrate wafer in a film thickness of 2 μm by a flexographic printing machine and attached to the liquid chamber substrate, and the adhesive is cured, thereby bonding the holding substrate and the liquid chamber substrate. After the liquid chamber substrate is polished from 600 μm thick to 80 μm thick, the pressure chamber and a fluid restrictor are formed by ICP dry etching, and the wafer is diced into chips to complete the channel substrate 120.

The housing 170 can be made of resin such as epoxy or polyphenylene sulfide (PPS), or metal such as stainless steel. The epoxy resin is used in the present embodiment. As illustrated in FIG. 3, the ink ports 171 and 172 are disposed on a back side (i.e., a side opposite the nozzles 111) to supply ink of one color or ink of two colors. A channel for feeding the ink supplied from the ink ports 171 and 172 to the internal channel of the channel substrate 120 is formed in the housing 170.

A printed circuit board for transmitting an electrical signal to the piezoelectric elements of the channel substrate 120 is disposed in the housing 170, and an electrical connector 191 for receiving the electrical signal from the outside is disposed on the housing 170.

The protector 180 projects outward from the nozzle face 110a of the nozzle plate 110 to protect the nozzle plate 110 from a print medium and a wiper. The protector 180 can be made of resin such as epoxy or PPS, or metal such as stainless steel. The epoxy resin is used in the present embodiment.

In the discharge head 100, the nozzle plate 110, the channel substrate 120 including the liquid chamber substrate and the holding substrate, and the housing 170 are laminated, and the protector 180 is also laminated over the housing 170.

An epoxy-based adhesive is applied to the prepared nozzle plate 110 in a film thickness of 2 μm by the flexographic printing machine and attached to the channel substrate 120, and the adhesive is cured, thereby bonding the nozzle plate 110 and the channel substrate 120. The printed circuit board is bonded to individual wiring pads of the liquid chamber substrate by anisotropic conductive film (ACF) bonding or wire bonding.

Next, the channel substrate 120 and the housing 170, and the housing 170 and the protector 180 are bonded to each other. Finally, the space between the nozzle plate 110, the housing 170, and the protector 180 is filled with the seal 181. Further, the seal 181 overlaps an area where the water repellent film on the nozzle plate 110 is removed. As a result, the edge (i.e., the outer edge portion 110b) of the nozzle plate 110 in the first direction is protected to withstand an external force.

A second embodiment of the present disclosure is described with reference to FIG. 4. FIG. 4 is a cross-sectional view, which is similar to FIG. 1, of the discharge head 100 according to the second embodiment.

The protector 180 includes a stepped portion formed on the housing 170 side and an overhang 180a opposed to the outer edge portion 110b extending in the second direction of the nozzle face 110a of the nozzle plate 110. In the present embodiment, the protector 180 is made of stainless steel. A rolled material with a thickness of 0.15 mm is processed by photolithography and wet etching to form a through opening and the step portion having a depth of 0.1 mm.

An adhesive 182 made of resin fills a space between the overhang 180a of the protector 180, the nozzle face 110a of the nozzle plate 110, and the surface of the housing 170 adjacent to the nozzle face 110a to bond the overhang 180a of the protector 180 and the nozzle face 110a of the nozzle plate 110 to each other.

In addition to the adhesive 182, the overhang 180a of the protector 180 covers the outer edge portion 110b of the nozzle face 110a in the first direction. The adhesive 182 and the overhang 180a over the adhesive extend in the second direction of the nozzle face 110a of the nozzle plate 110 along the outer edge portion 110b and is opposed to the nozzle face 110a in a region not overlapping the nozzles 111. In other words, the edge of the protector 180 adjacent to the nozzle plate 110 is located between the outer edge of the nozzle plate 110 and the nozzle region where the nozzles 111 are arrayed in plan view. That is, the adhesive 182 covers an end region between the outer edge portion 110b of the nozzle face 110a and the outer end of the nozzle region in the first direction.

Also in this embodiment, the liquid repellent film 113 is not disposed in the outer edge portion 110b of the nozzle face 110a of the nozzle plate 110 bonded to the protector 180 with the adhesive 182. With such a configuration, the edge (i.e., the outer edge portion 110b) of the nozzle plate 110 is protected by the protector 180 to withstand an external force.

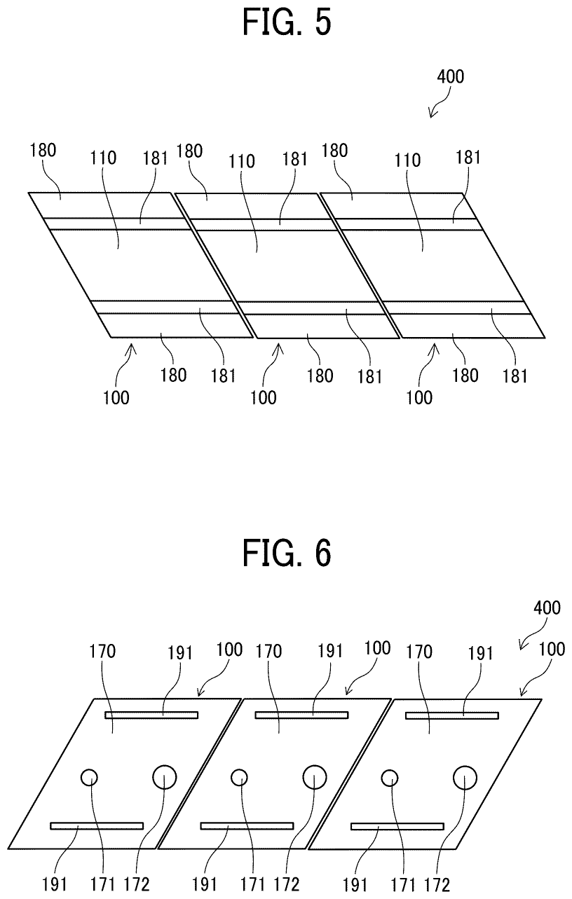

A third embodiment of the present disclosure is described with reference to FIGS. 5 and 6. FIG. 5 is a schematic plan view of a head module 400 according to a third embodiment as viewed from the nozzle face side thereof. FIG. 6 is a schematic plan view of the head module 400 as viewed from the port side thereof.

The head module 400 includes multiple discharge heads 100 arrayed in line in the second direction. Although one pair of the protectors 180 is provided for each of the multiple discharge heads 100 in the present embodiment, one or more pairs of common protectors 180 may be shared by the multiple discharge heads 100.

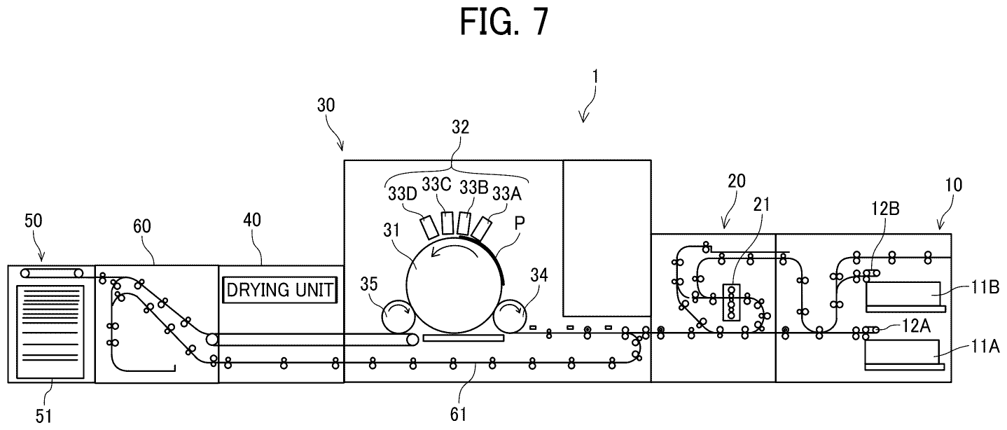

An example of a discharge apparatus according to embodiments of the present disclosure is described below with reference to FIG. 7. FIG. 7 is a schematic view of the discharge apparatus. A printer 1 as a discharge apparatus includes a loading unit 10 to load a sheet P into the printer 1, a pretreatment unit 20, a printing unit 30, a drying unit 40, a reverse unit 60, and an ejection unit 50.

In the printer 1, the pretreatment unit 20 applies, if desired, a pretreatment liquid onto the sheet P forwarded (supplied) from the loading unit 10, the printing unit 30 applies ink (liquid) to the sheet P to perform desired printing, the drying unit 40 dries the ink adhering to the sheet P, and the sheet P is ejected to the ejection unit 50.

The loading unit 10 includes loading trays 11 (a lower loading tray 11A and an upper loading tray 11B) to accommodate multiple sheets P and feeding devices 12 (a feeding device 12A and a feeding device 12B) to separate and feed the multiple sheets P one by one from the loading trays 11, and supplies the sheet P to the pretreatment unit 20. The pretreatment unit 20 includes, e.g., a coater 21 as a treatment-liquid application unit that coats a printing surface of the sheet P with a treatment liquid having an effect of aggregation of ink particles to prevent bleed-through.

The printing unit 30 includes a drum 31 and a liquid discharge device 32. The drum 31 is a bearer (rotator) that bears the sheet P on a circumferential surface of the drum 31 and rotates. The liquid discharge device 32 discharges the ink toward the sheet P bome on the drum 31. The printing unit 30 further includes transfer cylinders 34 and 35. The transfer cylinder 34 receives the sheet P from the pretreatment unit 20 and forwards the sheet P to the drum 31. The transfer cylinder 35 receives the sheet P conveyed by the drum 31 and forwards the sheet P to the drying unit 40.

The transfer cylinder 34 includes a sheet gripper to grip a leading end of the sheet P conveyed from the pretreatment unit 20 to the printing unit 30. The sheet P thus gripped is conveyed as the transfer cylinder 34 rotates. The transfer cylinder 34 forwards the sheet P to the drum 31 at a position opposite the drum 31.

Similarly, the drum 31 includes a sheet gripper on the surface of the drum 31, and the leading end of the sheet P is gripped by the sheet gripper of the drum 31. The drum 31 has a plurality of suction holes dispersedly on the surface of the drum 31, and a suction unit generates suction airflows directed inward from desired suction holes of the drum 31. On the drum 31, the sheet gripper grips the leading end of the sheet P forwarded from the transfer cylinder 34, and the sheet P is attracted to and bome on the drum 31 by the suction airflows by the suction unit. As the drum 31 rotates, the sheet P is conveyed. Thus, the drum 31 and the transfer cylinders 34 and 35 serve as a conveyor to convey the sheet P as a medium to the discharge head 100 in the liquid discharge device 32.

The liquid discharge device 32 includes discharge units 33 (discharge units 33A to 33D) to discharge liquids. For example, the discharge unit 33A discharges ink of cyan (C), the discharge unit 33B discharges ink of magenta (M), the discharge unit 33C discharges ink of yellow (Y), and the discharge unit 33D discharges ink of black (K). Further, the liquid discharge device 32 may include a discharge unit 33 that discharges special liquid, that is, ink of spot color such as white, gold, or silver.

The discharge unit 33 is, for example, a full-line head including the head module 400 including the multiple discharge heads 100 described above. A discharge operation of each of the discharge units 33 of the liquid discharge device 32 is controlled by a drive signal corresponding to print data. When the sheet P bome on the drum 31 passes through a region facing the liquid discharge device 32, the inks of respective colors are discharged from the discharge units 33, and an image corresponding to the print data is formed on the sheet P.

The drying unit 40 dries the ink applied onto the sheet P by the printing unit 30. Thus, a liquid component such as moisture in the ink evaporates, and the colorant contained in the ink is fixed on the sheet P. Additionally, curling of the sheet P is restrained.

The reverse unit 60 reverses, in switchback manner, the sheet P that has passed through the drying unit 40 in duplex printing. The reversed sheet P is fed back to the upstream side of the transfer cylinder 34 through a conveyance passage 61 of the printing unit 30.

The ejection unit 50 includes an ejection tray 51 on which a plurality of sheets P is stacked. The plurality of sheets P conveyed through the reverse unit 60 from the drying unit 40 is sequentially stacked and held on the ejection tray 51.

In the present disclosure, the material to be discharged is not limited to a particular material as long as the material has a viscosity or surface tension to be discharged from a head (discharge head). However, preferably, the viscosity of the material is not greater than 30 mPa-s under ordinary temperature and ordinary pressure or by heating or cooling. Examples of the material to be discharged include a solution, a suspension, or an emulsion including, for example, a solvent, such as water or an organic solvent, a colorant, such as dye or pigment, a functional material, such as a polymerizable compound, a resin, or a surfactant, a biocompatible material, such as DNA, amino acid, protein, or calcium, and an edible material, such as a natural colorant. Such a solution, a suspension, or an emulsion can be used for, e.g., inkjet ink; surface treatment liquid, a liquid for forming an electronic element component, a light-emitting element component, or an electronic circuit resist pattern; or a material solution for three-dimensional fabrication.

The term “discharge apparatus” used herein also represents an apparatus including the head module or the head device to drive the discharge head to discharge liquid. The term “discharge apparatus” used here includes, in addition to apparatuses to discharge liquid to a material onto which liquid (i.e., a material to be discharged) can adhere, apparatuses to discharge the liquid into gas (air) or liquid.

The “discharge apparatus” may further include devices relating to feeding, conveying, and ejecting of the material onto which liquid can adhere and also include a pretreatment device and an aftertreatment device.

The “discharge apparatus” may be, for example, an image forming apparatus to form an image on a sheet by discharging ink, or a three-dimensional apparatus to discharge fabrication liquid to a powder layer in which powder material is formed in layers to form a three-dimensional object.

The “discharge apparatus” is not limited to an apparatus that discharges liquid to visualize meaningful images such as letters or figures. For example, the discharge apparatus may be an apparatus that forms meaningless images such as meaningless patterns or an apparatus that fabricates three-dimensional images.

The above-described term “material onto which liquid can adhere” represents a material on which liquid is at least temporarily adhered, a material on which liquid is adhered and fixed, or a material into which liquid is adhered to permeate. Specific examples of the “material onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “material onto which liquid can adhere” includes any material to which liquid adheres, unless particularly limited.

Examples of the “material onto which liquid can adhere” include any materials to which liquid can adhere even temporarily, such as paper, thread, fiber, fabric, leather, metal, plastic, glass, wood, and ceramic.

The term “discharge apparatus” may be an apparatus to relatively move the discharge head and the material onto which liquid (i.e., a material to be discharged) can adhere. However, the liquid discharge apparatus is not limited to such an apparatus. For example, the discharge apparatus may be a serial head apparatus that moves the discharge head or a line head apparatus that does not move the discharge head.

Examples of the discharge apparatus further include: a treatment liquid applying apparatus that discharges a treatment liquid onto a surface of a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

As described above, according to the present disclosure, the outer edge portion of the nozzle plate can be protected.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A discharge head comprising:
a nozzle plate having a discharge face having nozzles from which a material is discharged in a discharge direction:
a channel substrate on the nozzle plate, the channel substrate having a channel communicating with the nozzles; and
a protector bonded to both sides of the nozzle plate in a first direction orthogonal to the discharge direction with a resin, the resin:
covering an outer edge portion of the discharge face in the first direction; and
extending in a second direction intersecting the first direction.

2. The discharge head according to claim 1,
wherein the discharge face of the nozzle plate has a nozzle region in which the nozzles are arrayed, and
the resin covers an end region between the outer edge portion of the discharge face and an outer end of the nozzle region in the first direction.

3. The discharge head according to claim 2,
wherein the protector covers the outer edge portion of the discharge face over the resin in the first direction.

4. The discharge head according to claim 3,
wherein the protector covers the end region over the resin in the first direction.

5. The discharge head according to claim 2, further comprising a liquid repellent film on the discharge face except for the end region covered with the resin.

6. The discharge head according to claim 1,
wherein the discharge face is recessed from a surface of the protector in the discharge direction.

7. The discharge head according to claim 2, further comprising a housing holding the nozzle plate and the channel substrate,
wherein the protector is bonded to both sides of the housing in the first direction, and the resin covers:
the end region; and
a surface of the housing between the outer edge portion of the discharge face and an inner edge of the protector bonded to the outer edge portion with the resin.

8. A head module comprising multiple discharge heads including the discharge head according to claim 1,
wherein the multiple discharge heads are arrayed in the second direction.

9. A discharge apparatus comprising:
the discharge head according to claim 1; and
a conveyor configured to convey a medium to the discharge head.

10. A discharge apparatus comprising:
the head module according to claim 8; and
a conveyor configured to convey a medium to the discharge head.
